(19) United States
(12) Patent Application Publication
(10) Pub. No.: US 2026/0296229 A1
(43) Pub. Date: Oct. 1, 2026

(54) CHARGER, AND CHARGER ASSEMBLY THEREOF

(71) Applicant: Wistron Corporation, New Taipei City (TW)

(72) Inventors: PO YUAN HSU, New Taipei City (TW); TSUNG HSIEN CHEN, New Taipei City (TW); CHIACHENG SU, New Taipei City (TW)

(21) Appl. No.: 19/210,102

(22) Filed: May 16, 2025

(30) Foreign Application Priority Data
Mar. 31, 2025 (TW) 114112444

(51) Int. Cl. B60L 53/16; H01R 13/621; H01R 24/28; H01R 24/76

(52) U.S. Cl. CPC B60L 53/16; H01R 13/621; H01R 24/28; H01R 24/76; H01R 2201/26

(57) ABSTRACT

A charger and a charger assembly thereof are provided. The charger includes a power connector and the charger assembly. The charger assembly includes a charging base and a base. The power connector includes multiple electrical terminals, and the charging base includes multiple electrical contacts. The base includes a base plate and a movable element. The base plate is suitable for being coupled to the charging base. The base plate has a plugging slot corresponding to the electrical contacts. The movable element is movably disposed on the base plate and is adjacent to the plugging slot. In response to the power connector being plugged into the plugging slot of the base, the electrical contacts are respectively connected to the electrical terminals, and the movable element is locked on the charging base.

### CROSS-REFERENCE TO RELATED APPLICATION

This non-provisional application claims priority under 35 U.S.C. § 119(a) to Patent Application No. 114112444 filed in Taiwan, R.O.C. on Mar. 31, 2025, the entire contents of which are hereby incorporated by reference.

### BACKGROUND

### Technical Field

The present disclosure relates to a charger assembly and a charger thereof, and in particular to an EV charger suitable for an electric vehicle or any other charging equipment with charging needs.

### Related Art

An EV charger or electric vehicle supply equipment (EVSE for short) is a power supply device designed to supply electric energy for on-board batteries of electric vehicles or plug-in hybrid vehicles, and it is also the most critical infrastructure in a process of popularizing electric vehicles. The EV charger may include a housing, a man-machine interface, a charging socket, a cable transfer terminal block, a safety protector and the like.

### SUMMARY

When mounting an EV charger, wires often need to be distributed in advance, and an enough wire length should be reserved such that the wires are inserted into the EV charger, which makes a mounting process labor-consuming and time-consuming. In addition, if the EV charger is disposed outdoors, there is also a risk of being stolen and pulled out.

In view of this, embodiments of the present disclosure provide a charger and a charger assembly thereof.

According to some embodiments, a charger includes a power connector, a charging base and a base. The power connector includes a plurality of electrical terminals, and the charging base includes a plurality of electrical contacts. The base includes a base plate and a movable element. The base plate is suitable for being coupled to the charging base. The base plate has a plugging slot corresponding to the electrical contacts. The movable element is movably disposed on the base plate. The movable element is adjacent to the plugging slot. In response to the power connector being plugged into the plugging slot of the base, the electrical terminals are respectively electrically connected to the electrical contacts, and the movable element is locked on the charging base.

According to some embodiments, a charger assembly is suitable for being plugged by a power connector having a plurality of electrical terminals to provide power. The charger assembly includes a charging base and a base. The charging base includes a plurality of electrical contacts. The electrical contacts correspond to the electrical terminals. The base includes a base plate and a movable element. The base plate is suitable for being coupled to the charging base. The base plate has a plugging slot corresponding to the electrical contacts. The movable element is suitable for being movably disposed on the base plate. The movable element is adjacent to the plugging slot. When the power connector is plugged into the plugging slot, the movable element is suitable for being locked on the charging base.

According to some embodiments, a charger assembly is suitable for being plugged by a power connector having a plurality of electrical terminals to provide power. The charger assembly includes a charging base and a base. The charging base includes a housing and a movable element. The housing has a plugging slot. The plugging slot has a plurality of electrical contacts therein. The electrical contacts correspond to the electrical terminals. The movable element is movably disposed on the housing. The movable element is adjacent to the plugging slot. The base is suitable for being coupled to the charging base. When the power connector is plugged into the plugging slot, the movable element is suitable for being locked on the base.

Based on the above, according to some embodiments, the mounted wires in the charger can be simplified, thereby reducing the mounting time and providing simple and beautiful appearance and mounting convenience. In some embodiments, the charger or the charger assembly cannot be easily stolen, and has an anti-theft function.

### BRIEF DESCRIPTION OF THE DRAWINGS

FIG. 1 depicts a schematic three-dimensional view of an EV charger according to an embodiment;

FIG. 2 depicts a schematic exploded view of the EV charger according to the embodiment;

FIG. 3 depicts a schematic exploded view (I) of a base according to the embodiment;

FIG. 4 is a schematic partial sectional view taken along line 4-4 in FIG. 1, where the dash-dotted lines represent a movable element located in a limit position;

FIG. 5 depicts a schematic exploded view (II) of the base according to another embodiment;

FIG. 6A depicts a schematic partial sectional view of the EV charger according to the another embodiment, showing that the movable element is located in a release position;

FIG. 6B depicts a schematic partial sectional view of the EV charger according to the another embodiment, showing that the movable element is located in the limit position;

FIG. 7 depicts a schematic exploded view (III) of the base according to the another embodiment;

FIG. 8 depicts a schematic partial three-dimensional view of the EV charger according to the another embodiment, showing that a power connector abuts against the movable element and the movable element is located in the limit position, where the dashed lines represent part of a base plate and part of a charging base;

FIG. 9 depicts a schematic partial sectional view taken along line 9-9 in FIG. 8, showing that a locking element is located at a limit section of a locking hole; and

FIG. 10 depicts a schematic three-dimensional view of an EV charger according to still another embodiment, where the dashed lines represent a movable element and a reset element located on an inner side surface of a base and mounted on a housing.

### DETAILED DESCRIPTION

Unless otherwise specified as electrical link or signal transmission, the term “connection” used in the following embodiments may be a physical connection, or a direct connection or indirect connection between physical components. In addition, the drawings of the present disclosure are only for schematic illustration, and are not necessarily drawn to scale, and all details are not necessarily presented in the drawings.

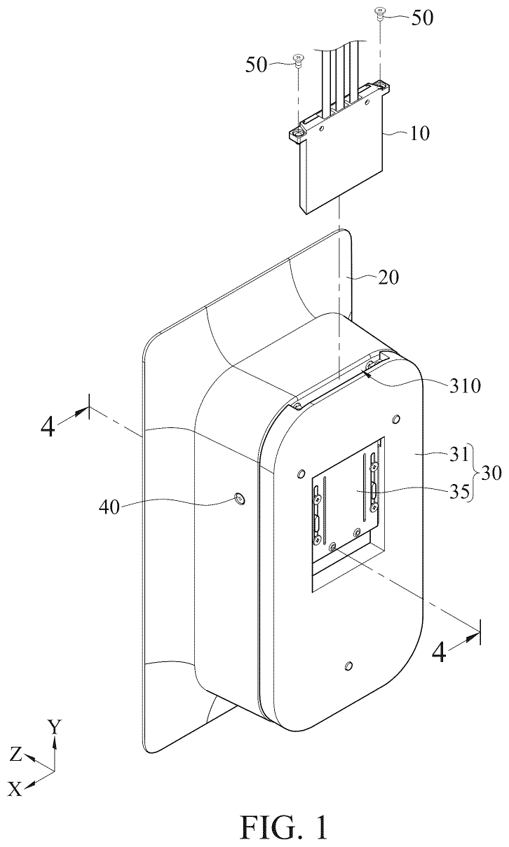

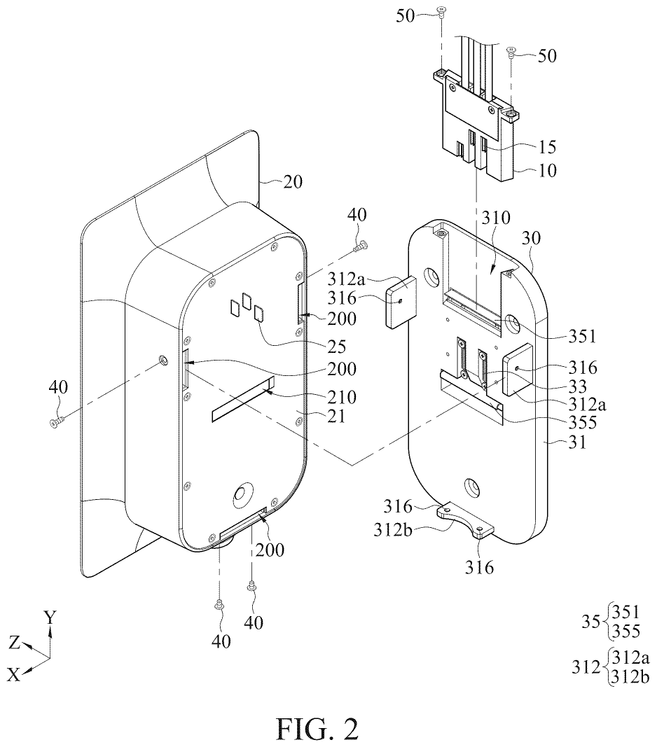

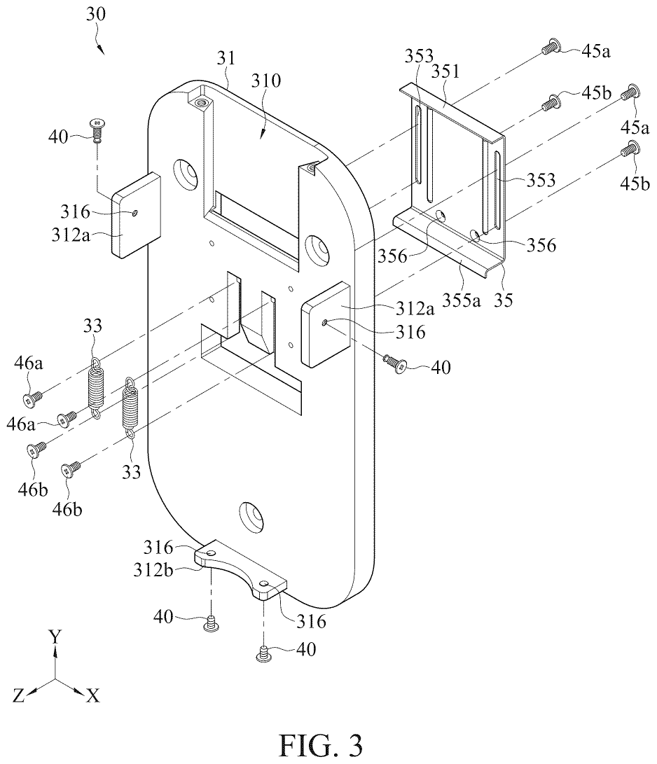

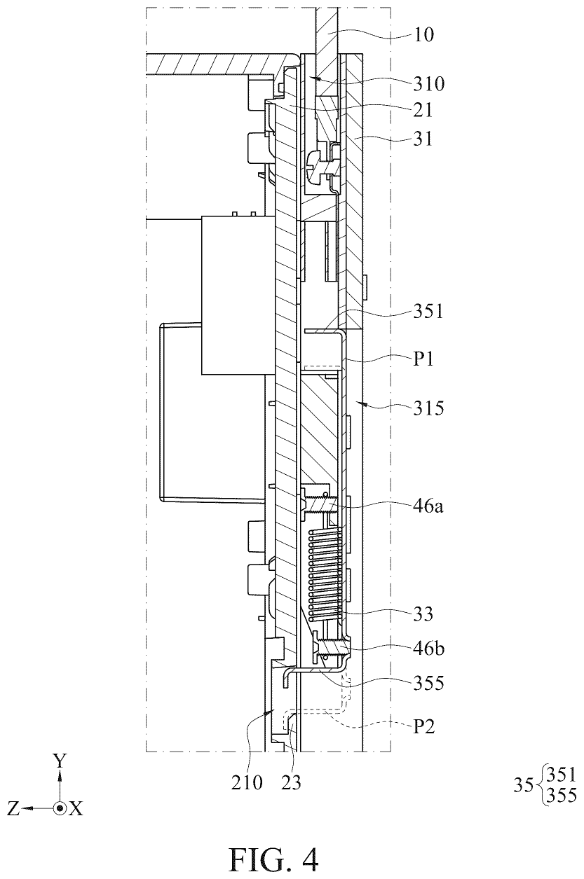

In order to facilitate a full description of the charger and the assembly thereof of the present disclosure, an EV charger used for electric vehicles will be taken as an example below, but the application object and protection scope of the present disclosure will not be limited to the EV charger. Referring to FIG. 1, FIG. 2, FIG. 3 and FIG. 4, FIG. 1 depicts a schematic three-dimensional view of an EV charger according to an embodiment. FIG. 2 depicts a schematic exploded view of the EV charger according to the embodiment. FIG. 3 depicts a schematic exploded view (I) of a base 30 according to the embodiment. FIG. 4 depicts a schematic partial sectional view taken along line 4-4 in FIG. 1, where the dash-dotted lines represent a movable element 35 located in a limit position P2.

Referring to FIG. 1, the EV charger includes a power connector 10 and an charger assembly. The EV charger is suitable for supplying electric energy https://zh.wikipedia.org/wiki/ [symbol] [symbol] for https://zh.wikipedia.org/wiki/ [symbol] on-board batteries https://zh.wikipedia.org/wiki/ [symbol] [symbol] of electric vehicles electric vehicles or https://zh.wikipedia.org/wiki/ [symbol] plug-in hybrid vehicles https://zh.wikipedia.org/wiki/ [symbol] . The charger assembly is suitable for providing a charging port and monitoring current and voltage states. The power connector 10 is configured to provide power to the charger assembly when being plugged into the charger assembly. The charger assembly includes a charging base 20 and a base 30 that can be coupled. The charging base 20 includes, for example, but not limited to, a housing, a control panel, a charging socket, a cable transfer terminal block and a safety protector. In some embodiments, the EV charger is wall-mounted, and the base 30 is suitable for being disposed on a wall.

Referring to FIG. 2, the power connector 10 includes a plurality of electrical terminals 15. The electrical terminals 15 are respectively connected to a plurality of wires. The wires are, for example, but not limited to, a ground wire, a live wire and a neutral line. The power connector 10 is suitable for being plugged into the base 30. The charging base 20 includes a plurality of electrical contacts 25, and the electrical contacts 25 protrude toward a base plate 31 of the base 30. The base 30 includes the base plate 31 and a movable element 35. The base plate 31 is suitable for being coupled to the charging base 20, for example, the charging base 20 may be sleeved on the base plate 31. The base plate 31 has a plugging slot 310, and the plugging slot 310 corresponds to the electrical contacts 25 of the charging base 20. When the power connector 10 is plugged into the base 30, the power connector 10 is plugged into the plugging slot 310 of the base plate 31, and the electrical contacts 25 are respectively electrically connected to the electrical terminals 15 (as shown in FIG. 2). The electrical terminals 15 and the electrical contacts 25 may be, for example, but not limited to, copper sheets. In addition, the power connector 10 plugged into the plugging slot 310 may be firmly coupled by the locking of locking elements 50 (such as screws or anti-theft screws). Therefore, the mounted wires in the charging base 20 can be simplified, thereby reducing the mounting time and providing simple and beautiful appearance and mounting convenience.

Referring to FIG. 4, the movable element 35 is movably disposed on the base plate 31, and the movable element 35 is adjacent to the plugging slot 310. In response to the power connector 10 being plugged into the plugging slot 310 of the base 30, the movable element 35 is locked on the charging base 20. That is, when the power connector 10 is plugged into the base 30, the movable element 35 limits the charging base 20 to the base plate 31, such that the charging base 20 cannot be separated from a coupling relationship with the base plate 31. Therefore, the movable element 35 can prevent relative movement and separation between the charging base 20 and the base 30 in at least one specific direction so as to maintain the coupling relationship between the charging base 20 and the base plate 31 of the base 30. Thereby, the EV charger or the charger assembly cannot be easily disassembled, and has an anti-theft function.

Further, referring to FIG. 4, in some embodiments, the movable element 35 is slidably disposed on the base plate 31 and has a release position P1 and a limit position P2. In response to the power connector 10 being plugged into the plugging slot 310 of the base 30, the movable element 35 is located in the limit position P2 so as to be locked on the charging base 20. When the movable element 35 is located in the release position P1, the movable element 35 is not locked on the charging base 20 such that the charging base 20 has a degree of freedom of movement in at least one specific direction relative to the base 30. In some embodiments, a mounting plate 21 of the charging base 20 has a locked portion 23, the movable element 35 includes an abutted portion 351 and a locking portion 355, and the movable element 35 is suitable for sliding from the release position P1 toward the limit position P2 by way of the abutted portion 351 being driven by the power connector 10. When the movable element 35 is located in the limit position P2, the locking portion 355 of the movable element 35 is locked on the locked portion 23 of the charging base 20 so as to limit the charging base 20 from being separated from the base 30 (base plate 31). In addition, when the movable element 35 is located in the release position P1, the locking portion 355 of the movable element 35 is not locked on the locked portion 23 of the charging base 20, and the charging base 20 is suitable for being separated from the base 30. In some embodiments, when the charging base 20 is sleeved on the base plate 31 and the movable element 35 is located in the release position P1, the charging base 20 has a degree of freedom in only one direction relative to the base plate 31. In other words, the movable element 35 may slide along the base plate 31 and be selectively located in the release position P1 and the limit position P2. When the movable element 35 is located in the limit position P2, the movable element 35 fixes the charging base 20 to the base plate 31. When the charging base 20 is sleeved on the base plate 31 and the movable element 35 is located in the release position P1, the charging base 20 has a degree of freedom in only one direction relative to the base plate 31.

The following describes the structural details of the charger assembly with an embodiment.

Referring to FIG. 2, in some embodiments, the base plate 31 includes insertion portions 312, the charging base 20 includes matching portions 200, and the charging base 20 is coupled to the base plate 31 by way of the matching portions 200 and the insertion portions 312 of the base plate 31 so as to have the degree of freedom of movement in the only one direction. Taking FIG. 2 as an example, the insertion portions 312 are flanges protruding toward the mounting plate 21 of the charging base 20, and the positions and number of the flanges are not limited. The base plate 31 in FIG. 2 has three insertion portions 312, where one insertion portion 312b and two insertion portions 312a are respectively located at a short side (bottom side) and long sides (left side and right side) of the base plate 31. In some embodiments, the base 30 further includes at least one locking element 40 and at least one corresponding locking holes 316. Taking FIG. 2 as an example, the base plate 31 has at least one corresponding locking hole 316, and the locking element 40 is suitable for extending through the charging base 20, the base plate 31 and the corresponding locking hole 316 of the movable element 35. Specifically, the insertion portions 312a, 312b may be respectively provided with the locking holes 316, and when the insertion portions 312a, 312b are respectively correspondingly inserted into the hole-shaped matching portions 200 of the mounting plate 21, the charging base 20 can be locked to the base plate 31 through the locking elements 40 (such as screws or anti-theft screws). Thereby, the charging base 20 can move relative to the base plate 31 along only one direction so as to be coupled to or separated from the base plate 31. The relative movement between the charging base 20 and the base plate 31 can only be along the protruding direction of the insertion portions 312 (for example, Z-axis in FIG. 2). In addition, the locking hole 316 has other variations, which will be described in the embodiments below.

Referring to FIG. 4, in some embodiments, the direction along which the movable element 35 slides between the release position P1 and the limit position P2 is substantially perpendicular to the only one direction along which the charging base 20 has the degree of freedom of movement. Taking FIG. 4 as an example, the charging base 20 is sleeved on the base plate 31, and when the movable element 35 is located in the release position P1, the charging base 20 is movable relative to the base plate 31 along the Z-axis. The release position P1 is a normal position of the movable element 35 on the base plate 31 when the charging base 20 is sleeved on the base plate 31. The charging base 20 has the degree of freedom of movement only along the Z-axis, and the direction along which the movable element 35 slides between the release position P1 and the limit position P2 is substantially parallel to a Y-axis. Therefore, the direction along which the movable element 35 slides is substantially perpendicular to the Z-axis along which the charging base 20 has the degree of freedom of movement. In this way, the movable element 35 located in the limit position P2 can limit the charging base 20 to the base plate 31 and make the charging base unable to be separated along the Z-axis.

Referring to FIG. 3, in some embodiments, the movable element 35 includes a basal plate 352, an abutted portion 351 and a locking portion 355, and the abutted portion 351 and the locking portion 355 are respectively located at two opposite ends of the basal plate 352 and protrude toward the mounting plate 21 (as shown in FIG. 4). Referring to FIG. 4, the base plate 31 further includes an accommodating slot 315. The accommodating slot 315 is configured to accommodate the movable element 35. The accommodating slot 315 is in communication with the plugging slot 310. The abutted portion 351 is located in the plugging slot 310.

Referring to FIG. 4, the movable element 35 is located in an accommodating slot 315. The abutted portion 351 protrudes from the plugging slot 310. A through hole 210 of the mounting plate 21 of the charging base 20 corresponds to the accommodating slot 315. The locking portion 355 of the movable element 35 may extend through the accommodating slot 315 and extend into the through hole 210. The mounting plate 21 is located on a side of the charging base 20 facing the base plate 31. In this way, the movable element 35 can be hidden into the charger assembly to serve as a hidden fastener of the charger assembly.

Referring to FIG. 4, in some embodiments, the movable element 35 is slidably disposed in the accommodating slot 315, and when the power connector 10 is plugged into the plugging slot 310, the power connector 10 abuts against the abutted portion 351 such that the movable element 35 is suitable for moving to the limit position P2. In other words, the movable element 35 is suitable for being pushed and driven to slide from the release position P1 toward the limit position P2 when the power connector 10 is plugged into the plugging slot 310. Specifically, referring to FIG. 3, fixing elements 45a, 45b extend through sliding slots 353 of the movable element 35 and are fixed to the base plate 31, and a distance between the fixing elements 45a, 45b is less than a longitudinal length of the sliding slots 353, i.e., a length along the Y-axis. In this way, the movable element 35 is slidably disposed on the fixing elements 45a, 45b by way of the sliding slots 353 and has the release position P1 and the limit position P2. The aforementioned fixing elements 45a, 45b are, for example, but not limited to, screws, rivets or other fixing components. Further, referring to FIG. 4, when the power connector 10 does not be plugged into the plugging slot 310, the movable element 35 is located in the release position P1, and the locking portion 355 of the movable element 35 is not locked on the locked portion 23 of the charging base 20 at a bottom edge of the through hole 210. After the power connector 10 is plugged into the plugging slot 310, the power connector 10 abuts against the abutted portion 351 of the movable element 35 and drives the locking portion 355 to be locked downward (in the −Y direction in the figure) onto the locked portion 23 of the charging base 20 at the bottom edge of the through hole 210. That is, when the movable element 35 is located in the limit position P2, the locking portion 355 may be locked on the mounting plate 21 such that the charging base 20 is fixed to the base plate 31 and cannot be separated from the base plate 31 along the Z-axis.

Therefore, when the charging base 20 is sleeved on the base plate 31 and the movable element 35 is located in the limit position P2, the movable element 35 can fix a relative position between the charging base 20 and the base plate 31 such that the charging base and the base plate cannot move relative to each other in the Z-axis direction. In this way, when the power connector 10 is plugged into the charger assembly, a hidden fastener inside the charger assembly can be activated at the same time. The movable element 35 slides from the release position P1 toward the limit position P2, the charging base 20 is fixed to the base plate 31, and the EV charger or the charger assembly cannot be easily removed and stolen. That is, even if the locking elements 40 (such as anti-theft screws) for locking the charging base 20 to the base 30 are intentionally damaged, the charging base 20 and the base 30 are still fastened by the hidden fastener (the locking portion 355 of the movable element 35 is locked on the locked portion 23) and thus cannot be easily disassembled and separated.

Referring to FIG. 3, in this embodiment, the base 30 further includes a reset element 33. The reset element 33 is configured to normally provide a restoring force such that the movable element 35 has potential energy to move toward the release position P1. The reset element 33 is, for example, but not limited to, a spring, a leaf spring, a torsion spring and an elastic component capable of generating the restoring force due to deformation. Referring to FIG. 3, one end of the reset element 33 is fixed to the base plate 31 through the fixing element 46a, and the other end is fixed to a fixing hole 356 of the movable element 35 through the fixing element 46b. The aforementioned fixing elements 46a, 46b are, for example, but not limited to, screws, rivets or other fixing components. Taking FIG. 4 as an example, when the power connector 10 is plugged into the charger assembly, the movable element 35 is driven to slide from the release position P1 to the limit position P2, and the reset element 33 is stretched and deformed. When the power connector 10 is pulled out of the charger assembly, the restoring force of the reset element 33 can push the movable element 35 from the limit position P2 toward the release position P1, such that the locking portion 355 of the movable element 35 is away from the locked portion 23 of the charging base 20.

Referring to FIG. 3 and FIG. 4, in some embodiments, the movable element 35 is one-piece. One end of the basal plate 352 extends toward the mounting plate 21 to form the abutted portion 351, and the other end extends toward the mounting plate 21 and bends toward the locked portion 23 to form the locking portion 355.

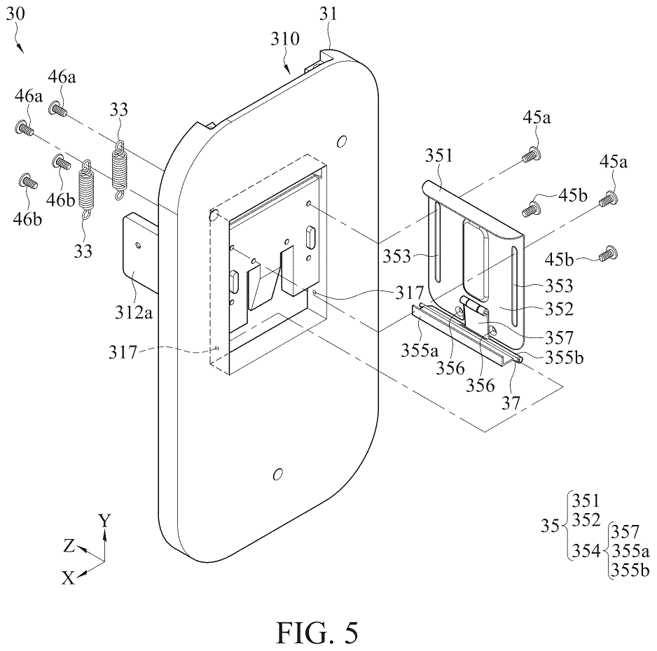

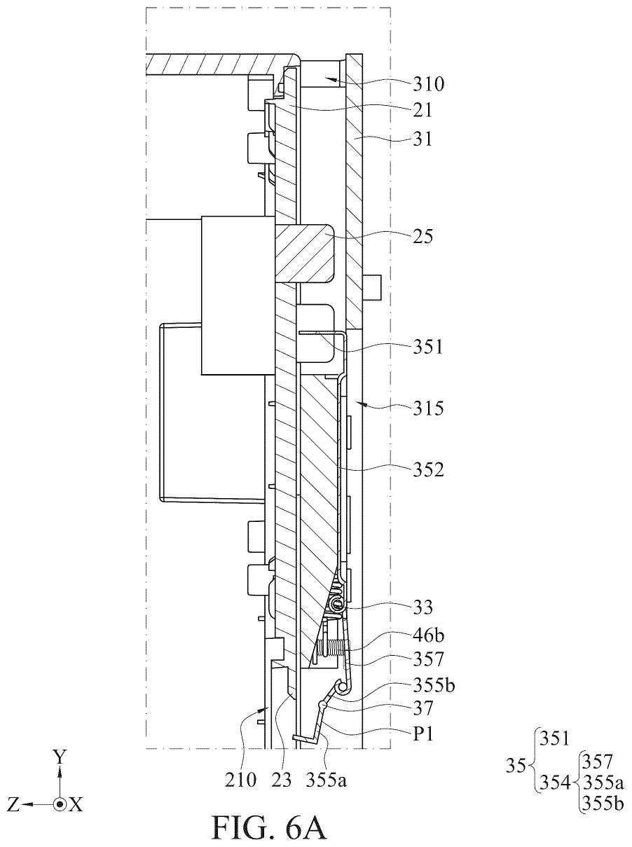

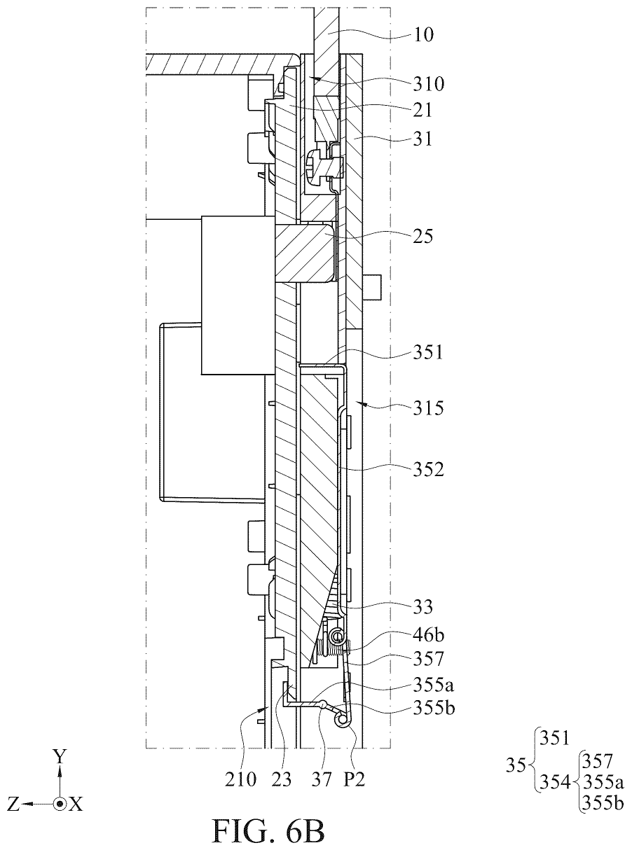

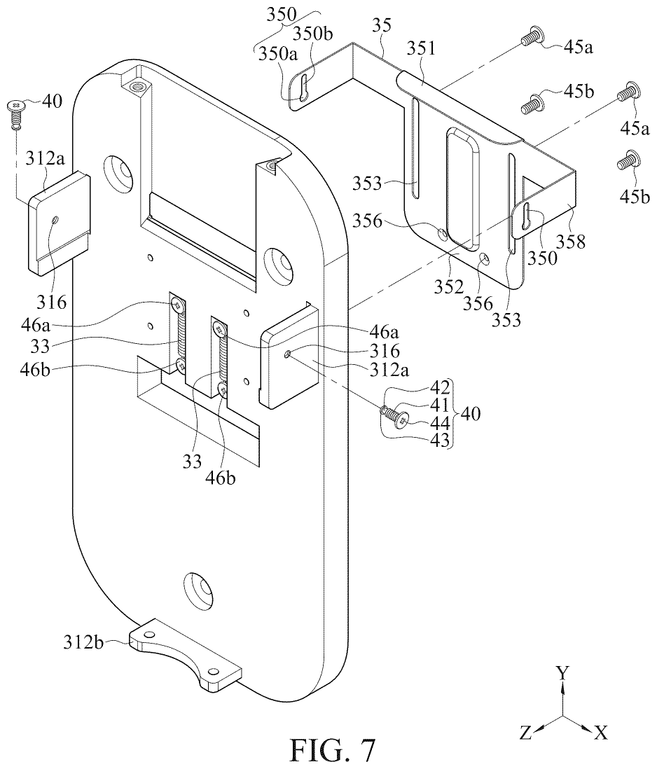

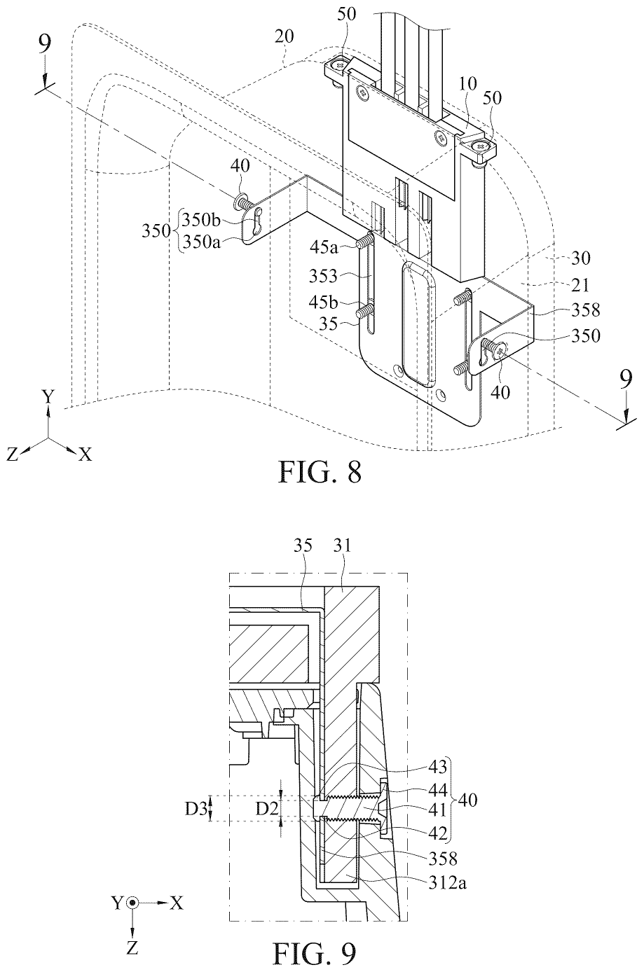

Referring to FIG. 5, FIG. 6A, FIG. 6B, FIG. 7, FIG. 8 and FIG. 9, FIG. 5 depicts a schematic exploded view (II) of the base 30 according to another embodiment. FIG. 6A depicts a schematic partial sectional view of the EV charger according to the another embodiment, showing that the movable element 35 is located in the release position P1. FIG. 6B depicts a schematic partial sectional view of the EV charger according to the another embodiment, showing that the movable element 35 is located in the limit position P2. FIG. 7 depicts a schematic exploded view (III) of the base 30 according to the another embodiment. FIG. 8 depicts a schematic partial three-dimensional view of the EV charger according to the another embodiment, showing that a power connector 10 abuts against the movable element 35 and the movable element 35 is located in the limit position P2, where the dashed lines represent part of the base plate 31 and part of the charging base 20. FIG. 9 depicts a schematic partial sectional view taken along line 9-9 in FIG. 8, showing that the locking element 40 is located at a limit section 350b of a locking hole 350.

Referring to FIG. 5, in the another embodiment, the movable element 35 is multi-piece. The movable element 35 includes a basal plate 352 and a hook plate 354. One end of the hook plate 354 is pivoted to one end of the basal plate 352, and the other end of the hook plate 354 has the locking portion 355. Taking FIG. 5 as an embodiment, the hook plate 354 has a pivoting plate 357 and the locking portion 355. The locking portion 355 has a bending section 355a and a pivoting section 355b. Two ends of the pivoting plate 357 are respectively pivoted to the basal plate 352 and the pivoting section 355b of the locking portion 355. A joint between the pivoting section 355b and the pivoting plate 357 is fixed to the fixing hole 317 of the base plate 31 through a shaft lever 37. Thereby, when the abutted portion 351 of the basal plate 352 slides from the release position P1 toward the limit position P2, the locking portion 355 correspondingly rotates around the shaft lever 37.

For example, referring to FIG. 6A, when the movable element 35 is located in the release position P1, the hook plate 354 is located in the accommodating slot 315, and the bending section 355a of the locking portion 355 is not locked on the locked portion 23 of the charging base 20. Referring to FIG. 6B, when the power connector 10 is plugged into the plugging slot 310 of the base 30, the power connector 10 abuts against the abutted portion 351 of the movable element 35 and drives the hook plate 354 to pivot such that the locking portion 355 is locked upward (in the +Y direction in the figure) onto the locked portion 23 of the charging base 20. In other words, when the movable element 35 slides from the release position P1 toward the limit position P2, the basal plate 352 correspondingly slides along the −Y-axis, and the basal plate 352 drives the locking portion 355 of the hook plate 354 to rotate around the shaft lever 37 in the clockwise direction from the viewing angle of FIG. 6, such that the curved section 355a can be locked on the locked portion 23 of the charging base 20.

Referring to FIG. 7, in other embodiments, the base 30 further includes a locking element 40. The locking element 40 includes a head portion 44, a rod portion 41, a neck portion 42 and an end portion 43. Two ends of the rod portion 41 are respectively the head portion 44 and the end portion 43. The head portion 44 has a cross-shaped or straight geometric structure so as to be torqued such that the locking element 40 is locked or separated from the charger assembly. The neck portion 42 is a recess between the rod portion 41 and the end portion 43. In some embodiments, the locking element 40 is, for example, but not limited to a screw or an anti-theft screw, and the rod portion 41 has a thread. In another aspect, the movable element 35 further includes an extending portion 358. The extending portion 358 protrudes from one side of the basal plate 352 toward the mounting plate 21 and extends through the base plate 31 and is located on an inner side of the insertion portion 312. The extending portion 358 has the locking hole 350. Referring to FIG. 7 and FIG. 9, the locking element 40 extends through the charging base 20, the insertion portion 312a (the locking hole 316 in FIG. 7) of the base plate 31 and the extending portion 358 (the locking hole 350 in FIG. 7) of the movable element 35.

Referring to FIG. 8, in other embodiments, the locking hole 350 has a limit section 350b and an assemble-in section 350a. The limit section 350b of the locking hole 350 is in communication with the assemble-in section 350a, and a width of the limit section 350b is less than a width of the assemble-in section 350a. Referring to FIG. 9, a width D2 of the neck portion 42 of the locking element 40 corresponds to the width of the limit section 350b of the locking hole 350, and a width D3 of the end portion 43 of the locking element 40 corresponds to the width of the assemble-in section 350a of the locking hole 350. Specifically, along the Z-axis, the width D2 of the neck portion 42 of the locking element 40 is less than the width D3 of the end portion 43, the width D3 of the end portion 43 of the locking element 40 is greater than the width of the limit section 350b of the locking hole 350, and the width D2 of the neck portion 42 of the locking element 40 is substantially equal to or less than the width of the limit section 350b of the locking hole 350. In some embodiments, the locking hole 350 is a gourd-shaped opening. In this way, the locking element 40 cannot be easily separated from the locking hole 350 when sliding at the limit section 350b of the locking hole 350.

In addition, referring to FIG. 8, in some embodiments, a direction along which the limit section 350b and the assemble-in section 350a are arranged is substantially parallel to the direction along which the movable element 35 slides. For example, when the movable element 35 is located in the release position P1, the neck portion 42 of the locking element 40 is located at the assemble-in section 350a of the locking hole 350. At this time, the locking element 40 does not interfere with the sliding of the movable element 35, and the locking element 40 can be operated to be separated from the base plate 31 and the charging base 20. When the movable element 35 slides from the release position P1 toward the limit position P2, the locking hole 350 of the movable element 35 also moves in the same direction relative to the locking element 40. Thereby, when the movable element 35 is located in the limit position P2, the neck portion 42 of the locking element 40 is also located at the limit section 350b of the locking hole 350 (as shown in FIG. 8), such that the limit section 350b limits the locking element 40 to the base plate 31 and the charging base 20 is fixed to the base plate 31. In this way, when the power connector 10 is plugged into the charger assembly, the hidden fastener (movable element 35) inside the charger assembly is activated, and the locking element 40 extending through the movable element 35 is limited and cannot be loosened and removed freely, such that the movable element 35 cannot be easily released from the limit position P2 and restored to the release position P1. Therefore, the EV charger or the charger assembly cannot be easily disassembled and stolen.

In the another embodiments of FIG. 7 to FIG. 9, an anti-theft screw structure formed by the matching mechanism between the locking element 40 and the locking hole 350 can be applied to the movable element 35 not only in the embodiments of FIG. 1 to FIG. 4, but also in the aforementioned embodiments of FIG. 5 to FIG. 6B, so as to further enhance an anti-theft function that the charging base 20 is not easily detached from the base 30. In addition, although the movable element 35 of the present disclosure is illustrated as being slidably disposed on the base 30 as an example in the above embodiments, it is not excluded that the movable element is movably disposed on the base 30 by using a mechanism such as a lever or a pivot, so as to be driven to be locked on the charging base 20 when being inserted by the power connector 10.

As can be seen from the embodiments of FIG. 1 to FIG. 4 and the embodiments of FIG. 5 to FIG. 6B, in the present disclosure, the charging base 20 and the base 30 are first coupled and limited to be unable to be separated freely in the X-axis and Y-axis directions, and then the power connector 10 is inserted to form an electrical connection and also drive the movable element 35 on the base 30 to be locked on the charging base 20 toward the +Y or -Y direction, so as to further limit the charging base 20 and the base 30 from being separated freely in the Z-axis direction. However, in other embodiments, the direction along which the charging base 20 and the base 30 that are coupled are limited, and the direction along which the movable element 35 is locked can be adjusted and changed as needed.

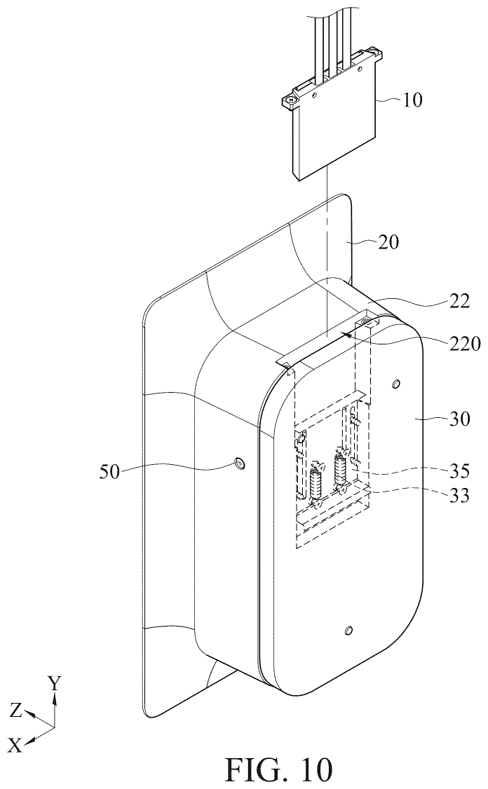

In addition, referring to FIG. 10, in other embodiments, the charger assembly includes a charging base 20 and a base 30. The charging base 20 includes a housing 22 and a movable element 35. The housing 22 has a plugging slot 220. The plugging slot 220 has a plurality of electrical contacts 25 therein. The electrical contacts 25 correspond to a plurality of electrical terminals 15 of a power connector 10 (the detailed structure is similar to FIG. 2). The movable element 35 is suitable for being movably disposed on the housing 22, and the movable element 35 is adjacent to the plugging slot 220. The base 30 is suitable for being coupled to the charging base 20. When the power connector 10 is plugged into the plugging slot 220, the movable element 35 is suitable for being locked on the base 30. In other words, the plugging slot 310 originally provided in the base 30 is provided in the charging base 20, the plugging slot 220 of the charging base 20 includes the plurality of electrical contacts 25 therein, and the movable element 35 and related structures and matching components are also changed from being originally arranged in the base 30 to being arranged in the charging base 20, so an object on which the movable element 35 is locked is changed from the charging base 20 in the previous embodiments to the base 30. Since those of ordinary skill in the art can easily understand the specific details of the transposition and replacement in the positions of the movable element 35 and the related locking mechanism from the base 30 to the charging base 20 in this embodiment, the drawings and the detailed description will not be redundantly disclosed here.

Although the present disclosure has been described in considerable detail with reference to certain preferred embodiments thereof, the disclosure is not for limiting the scope of the invention. Persons having ordinary skill in the art may make various modifications and changes without departing from the scope and spirit of the disclosure. Therefore, the scope of the appended claims should not be limited to the description of the preferred embodiments described above.

What is claimed is:

1. A charger, comprising:
a power connector, comprising a plurality of electrical terminals;
a charging base, comprising a plurality of electrical contacts; and
a base, comprising:
a base plate, suitable for being coupled to the charging base, wherein the base plate has a plugging slot corresponding to the plurality of electrical contacts; and
a movable element, movably disposed on the base plate, the movable element being adjacent to the plugging slot, wherein in response to the power connector being plugged into the plugging slot of the base, the electrical terminals are respectively electrically connected to the electrical contacts, and the movable element is locked on the charging base.

2. The charger according to claim 1, wherein the movable element is slidably disposed on the base plate and has a limit position and a release position; in response to the power connector being plugged into the plugging slot of the base, the movable element is in the limit position to be locked on the charging base; and when the movable element is in the release position, the movable element is not locked on the charging base such that the charging base has a degree of freedom of movement in at least one specific direction relative to the base.

3. The charger according to claim 2, wherein the charging base has a locked portion; the movable element comprises an abutted portion and a locking portion; the movable element is suitable for sliding from the release position toward the limit position by way of the abutted portion being driven by the power connector; when the movable element is in the limit position, the locking portion of the movable element is locked on the locked portion of the charging base so as to limit the charging base from being separated from the base; and when the movable element is in the release position, the locking portion of the movable element is not locked on the locked portion of the charging base, and the charging base is suitable for being separated from the base.

4. The charger according to claim 3, wherein the base plate has an accommodating slot; the accommodating slot is in communication with the plugging slot; the movable element is slidably disposed in the accommodating slot; the abutted portion is in the plugging slot; and when the power connector is plugged into the plugging slot, the power connector abuts against the abutted portion such that the movable element is suitable for moving to the limit position.

5. The charger according to claim 3, wherein the movable element further comprises a basal plate and a hook plate; one end of the hook plate is pivoted to one end of the basal plate, an other end of the hook plate has the locking portion, and an other end of the basal plate has the abutted portion; and when the power connector is plugged into the base, the power connector abuts against the abutted portion and drives the hook plate to pivot such that the locking portion is locked on the locked portion.

6. The charger according to claim 2, wherein the base further comprises at least one locking element; the movable element has at least one corresponding locking hole; and each of the locking elements is suitable for extending through the charging base, the base plate and one of the corresponding locking holes of the movable element.

7. The charger according to claim 6, wherein each of the corresponding locking holes has an assemble-in section and a limit section; when the movable element is in the release position, a neck portion of each of the locking elements is at the assemble-in section of one of the corresponding locking holes; and when the movable element is in the limit position, the neck portion of each of the locking elements is at the limit section of one of the corresponding locking holes such that the limit section limits the charging base to the base plate.

8. The charger according to claim 7, wherein a width of the neck portion of each of the locking elements corresponds to a width of the limit section of each of the corresponding locking holes; a width of an end portion of each of the locking elements corresponds to a width of the assemble-in section of each of the corresponding locking holes; and the width of the neck portion of each of the locking elements is less than the width of the end portion of each of the locking elements.

9. The charger according to claim 2, wherein the base further comprises a reset element; one end of the reset element is fixed to the base plate and an other end is fixed to the movable element; and the reset element normally provides a restoring force such that the movable element has potential energy to move toward the release position.

10. The charger according to claim 2, wherein the base plate comprises at least one insertion portion; the charging base comprises at least one corresponding matching portion; and the charging base is suitable for being coupled to the base plate by way of the at least one insertion portion being inserted into one of the corresponding matching portions, and is limited to have the degree of freedom of movement only in the at least one specific direction.

11. A charger assembly, suitable for being plugged by a power connector having a plurality of electrical terminals to provide power, comprising:
a charging base, comprising a plurality of electrical contacts, wherein the plurality of electrical contacts correspond to the plurality of electrical terminals; and
a base, comprising:
a base plate, suitable for being coupled to the charging base, wherein the base plate has a plugging slot corresponding to the plurality of electrical contacts; and
a movable element, movably disposed on the base plate, the movable element being adjacent to the plugging slot, wherein when the power connector is plugged into the plugging slot, the movable element is suitable for being locked on the charging base.

12. The charger assembly according to claim 11, wherein the movable element is slidably disposed on the base plate and has a limit position and a release position; the movable element is in the limit position to be locked on the charging base; and when the movable element is in the release position, the movable element is not locked on the charging base such that the charging base has a degree of freedom of movement in at least one specific direction relative to the base.

13. The charger assembly according to claim 12, wherein the charging base has a locked portion; the movable element has an abutted portion and a locking portion; when the movable element is in the limit position, the locking portion of the movable element is locked on the locked portion of the charging base so as to limit the charging base from being separated from the base; and when the movable element is in the release position, the locking portion of the movable element is not locked on the locked portion of the charging base, and the charging base is suitable for being separated from the base.

14. The charger assembly according to claim 13, wherein the base plate has an accommodating slot; the accommodating slot is in communication with the plugging slot; and the movable element is slidably disposed in the accommodating slot and the abutted portion protrudes outward from the plugging slot.

15. The charger assembly according to claim 13, wherein the movable element comprises a basal plate and a hook plate; one end of the hook plate is pivoted to one end of the basal plate and an other end of the hook plate has the locking portion; and when the movable element slides from the release position toward the limit position, the hook plate is driven to pivot such that the locking portion is locked on the locked portion.

16. The charger assembly according to claim 12, wherein the base further comprises a locking element; the movable element has a locking hole; and the locking element extends through the charging base, the base plate and the locking hole of the movable element.

17. The charger assembly according to claim 12, wherein the base further comprises a reset element; one end of the reset element is fixed to the base plate and an other end is fixed to the movable element; and the reset element normally provides a restoring force such that the movable element has potential energy to move toward the release position.

18. The charger assembly according to claim 12, wherein the base plate comprises at least one insertion portion; the charging base comprises at least one corresponding matching portion; and the charging base is coupled to the base plate by way of the at least one insertion portion being inserted into one of the corresponding matching portions, and is limited to have the degree of freedom of movement only in the at least one specific direction.

19. A charger assembly, suitable for being plugged by a power connector having a plurality of electrical terminals to provide power, comprising:
a charging base, comprising:
a housing, having a plugging slot, wherein the plugging slot has a plurality of electrical contacts therein, and the plurality of electrical contacts correspond to the plurality of electrical terminals; and
a movable element, movably disposed on the housing, wherein the movable element is adjacent to the plugging slot; and
a base, suitable for being coupled to the charging base, wherein when the power connector is plugged into the plugging slot, the movable element is suitable for being locked on the base.

20. The charger assembly according to claim 19, wherein the movable element is slidably disposed on the housing and has a limit position and a release position; the movable element has a locking portion; when the movable element is in the limit position, the locking portion of the movable element is locked on the base so as to limit the charging base from being separated from the base; and when the movable element is in the release position, the locking portion of the movable element is not locked on the base, and the charging base is suitable for being separated from the base.
